(19) United States
(12) Patent Application Publication
(10) Pub. No.: US 2016/0093010 A1
(43) Pub. Date: Mar. 31, 2016

(54) MULTI-PAYER CLINICAL DOCUMENTATION E-LEARNING PLATFORM

(71) Applicants: Ingrid Vasiliu-Feltes, Miami, FL (US); Edison Sabala, Miami, FL (US); Andres Jimenez, Dallas, TX (US)

(72) Inventors: Ingrid Vasiliu-Feltes, Miami, FL (US); Edison Sabala, Miami, FL (US); Andres Jimenez, Dallas, TX (US)

(21) Appl. No.: 14/576,626

(22) Filed: Dec. 19, 2014

Related U.S. Application Data
(60) Provisional application No. 62/057,215, filed on Sep. 29, 2014.

(51) Int. Cl. G06Q 50/22; G06Q 10/06; G06F 19/00

(52) U.S. Cl. CPC G06Q 50/22; G06F 19/322; G06Q 10/06316

(57) ABSTRACT

A multi-payer clinical documentation e-learning platform and methods for educating at least one health professional about medical necessity criteria associated with a plurality of health plans are described herein. An example method can commence with dynamically compiling health plan data associated with the plurality of health plans. The method may include analyzing the health plan data to extract the medical necessity criteria for at least one medical procedure. The method may further include selectively integrating a health record workflow with one or more e-learning sessions to educate the at least one health professional about the medical necessity criteria in the context of the at least one medical procedure.

### RELATED APPLICATIONS

The present application claims the benefit of U.S. provisional application No. 62/057,215, filed on Sep. 29, 2014. The subject matter of the aforementioned application is incorporated herein by reference for all purposes.

### TECHNICAL FIELD

The present disclosure relates generally to data processing and, more specifically, to methods and systems for educating and supporting health professionals about medical necessity criteria associated with a plurality of health plans.

### BACKGROUND

The healthcare environment is increasingly demanding on physicians. There are multiple and revolutionary changes occurring in healthcare including policy changes, new reimbursement models, electronic record implementation, quality and safety reporting mandates, transition to a new international disease classification system, and increased limitations and restrictions imposed by healthcare plans and managed care organizations to control utilization rates that exponentially increase with time. Specifically, adoption of new statutes (e.g., Accountable Care Act), creation of federal Healthcare Exchanges, and an increasing number of managed health plans have placed overwhelming stress on both physicians and administrative staff who keep track of new policies, bulletins, and guidelines defining medical necessity. Administrators, case managers, and contracting staff of healthcare organizations have traditionally been the only ones trained to understand, follow, and apply the medical necessity criteria and coverage determination bulletins. However, the changing healthcare landscape (with emphasis on value-based payments with numerous quality metrics that heavily depend on accurate, detailed, specific documentation) requires new tools for physician education. Medical schools, residency, and fellowship training programs do not prepare healthcare professionals for any of these challenges.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are systems and methods for educating at least one health professional about medical necessity criteria associated with a plurality of health plans. The method for educating at least one health professional about medical necessity criteria associated with a plurality of health plans can comprise dynamically compiling health plan data associated with the plurality of health plans. The health plan data can include at least one of the following: a medical policy, a guideline, a documentation requirement, a coverage determination criterion, and a medical necessity criterion. The health plan data can be analyzed to extract the medical necessity criteria for at least one medical procedure. The medical procedure can include a medical service, a surgery rendered to a patient, a laboratory examination, an imaging, a medication, and so forth. The analysis can include mining the data for billing and claim information and performing a detailed payer (e.g., a health plan) analysis. A health record workflow can be selectively integrated with one or more e-learning sessions to educate or support the at least one health professional about the medical necessity criteria in the context of the at least one medical procedure. The health record workflow can include an Electronic Health Records (EHR) workflow.

For example, it may be determined that an active health record associated with a health record workflow is related to medical necessity criteria. Based on the determination, an appropriate e-learning session may be activated. The e-learning session may be provided to the at least one health professional via a mobile technology, a web-based technology, or by some other means. The e-learning sessions may employ voice recognition tools to enable voice control. Additionally, to support search within the e-learning sessions, between sessions, and overall across the e-learning platform, machine learning technologies can be applied. The e-learning session may be operable to train the at least one health professional on how to document clinical findings in order to satisfy medical necessity criteria for one or more payers.

Furthermore, an example method may comprise analyzing claims data produced by a health record workflow in view of the medical necessity criteria. Based on the analysis, recommendations may be provided to the at least one healthcare professional. Additionally, one or more reports produced by one or more third parties may be analyzed and, based on the analysis, various actions can be recommended to the at least one healthcare professional. Moreover, health plan data associated with the plurality of health plans may be periodically recompiled to update the medical necessity criteria associated with the plurality of health plans.

In another embodiment, a multi-payer clinical documentation e-learning platform may be provided. The multi-payer clinical documentation e-learning platform may comprise a database, a processor, and an integration module. The database may be operable to dynamically compile health plan data associated with a plurality of health plans. The processor can be operable to analyze the data to extract the medical necessity criteria for at least one medical procedure. The integration module can be operable to selectively integrate health records with one or more e-learning sessions to educate and support the at least one health professional about the medical necessity criteria in the context of the at least one medical procedure.

### BRIEF DESCRIPTION OF THE DRAWINGS

Embodiments are illustrated by way of example and not limitation in the figures of the accompanying drawings, in which like references indicate similar elements and in which:

FIG. 1 illustrates an environment within which a multi-payer clinical documentation e-learning platform and methods for educating at least one health professional about medical necessity criteria associated with a plurality of health plans can be implemented, in accordance with some example embodiments.

FIG. 2 is a block diagram showing various modules of the multi-payer clinical documentation e-learning platform, in accordance with some example embodiments.

FIG. 3 is a flow chart illustrating a method for educating at least one health professional about medical necessity criteria associated with a plurality of health plans, in accordance with some example embodiments.

FIG. 4 shows an example analysis of health plan data and a composition of an e-learning session.

FIG. 5 shows medical necessity criteria for a bariatric surgery according to various health plan providers, in accordance with some example embodiments.

FIG. 6 shows example screens of the e-learning platform, in accordance with some example embodiments.

FIG. 7 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

Medical necessity is a legal doctrine, related to procedures and services which may be justified as reasonable, necessary, and/or appropriate according to evidence-based clinical standards of care. Medical insurance companies pay for medical procedures and services that are “reasonable and necessary” for a variety of purposes, for example, for the diagnosis or treatment of illness or injury or to improve the functioning of a malformed body member. However, different medical insurance companies who are the payers of medical expenses have varying rules and policies regarding the medical necessity of various medical procedures. Complying with these rules and policies may be extremely challenging for a health professional. Therefore, a seamless electronic educational platform to aid healthcare professionals meet the numerous complex medical necessity criteria established by payers within the healthcare system is desirable.

Conventional educational platforms for healthcare professionals have been focused on continuous medical education (CMEs), clinical practice guidelines, and research. Other platforms leverage advances in healthcare analytics and technology to facilitate and monitor healthcare professional performance. Some of the e-learning tools available to medical and surgical care providers (for example, Computer Assisted Coding, ICD 10 Coding, Meaningful Use (MU) and Physician Quality Reporting System (PQRS) reporting, and population health management) require extensive mass training, are not customized for individual providers, and are mostly offered in the pre-implementation phase of new enterprise solutions. Implementations of these enterprise-wide solutions, however, often require major workflow changes, burden clinicians and staff, and cause major operational disruptions. All of these issues often cause strong resistance from healthcare professionals already overwhelmed by heavy patient loads. Therefore, an electronic educational tool that is easily deployed is desirable to aid healthcare professionals in clinical documentation to meet the numerous complex medical necessity criteria established by the dominant payers within the healthcare system.

This disclosure describes an example multi-payer clinical documentation e-learning platform to help healthcare professionals meet the requirements for medical necessity criteria set forth by multiple payers for medical or surgical services rendered to patients. The multi-payer clinical documentation e-learning platform (e.g., Thelos Medical Necessity HealthKit) can leverage an existing electronic format capable of providing real-time analytics and personalized feedback for trainees as well as content mapping and integrated search capabilities. Customized, high yield e-learning solutions can be designed to educate physicians about specific medical necessity criteria for patients belonging to different health plans. Additionally, the e-learning solution can support a healthcare professional in daily activity when making a decision or planning a patient treatment. The multi-payer clinical documentation e-learning platform can enable targeted, scalable, customized, and relevant education as well as quick support (decision or performance support in the planning or execution phases). The e-learning process requires minimal healthcare professional training time, is self-paced and fully integrated with any EHR, and does not cause disruptions in the workflow of a health professional.

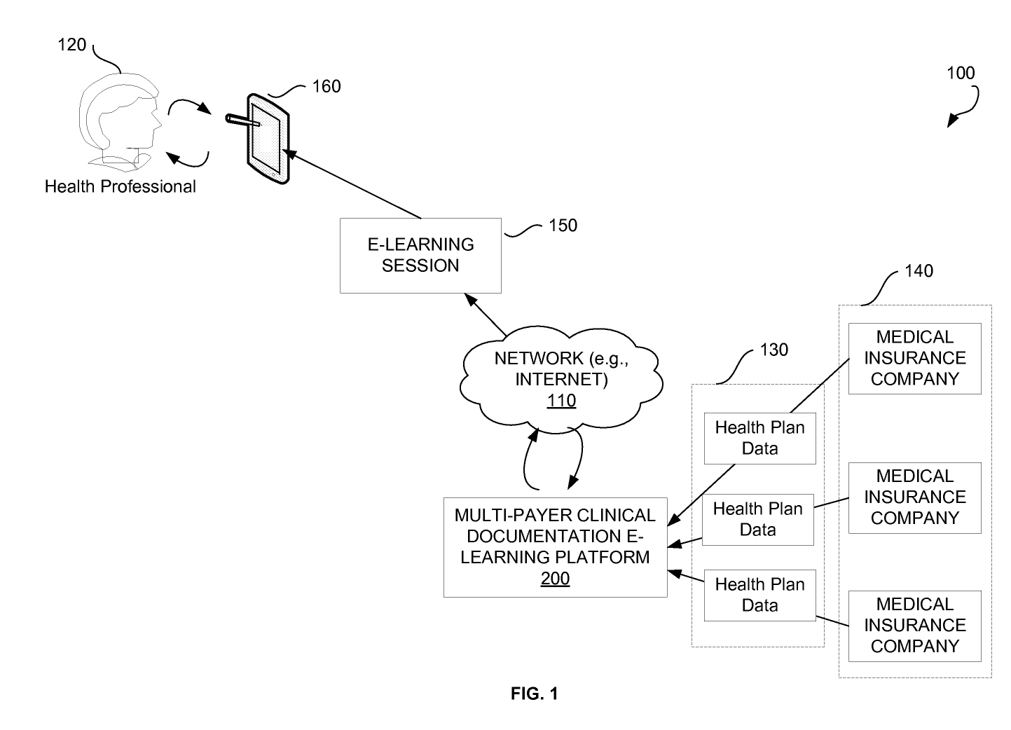

FIG. 1 illustrates an environment 100 within which a multi-payer clinical documentation e-learning platform 200 and methods for educating at least one health professional about medical necessity criteria associated with a plurality of health plans can be implemented, in accordance with some example embodiments. The multi-payer clinical documentation e-learning platform 200 can be a server-based distributed application; thus, it may include a central component residing on a server and one or more client applications residing on work stations and communicating with the central component via a network 110. One or more health professionals 120 can communicate with the multi-payer clinical documentation e-learning platform 200 via a client application available through a client device 160 (for example, a smart phone, a tablet personal computer (PC), a laptop, and so forth).

The network 100 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may include a network of data processing nodes that are interconnected for the purpose of data communication.

The multi-payer clinical documentation e-learning platform 200 may provide highly customized content based on evaluating and compiling a library of published medical policies, guidelines, coverage determination, and medical necessity criteria for all relevant payers. Health plan data 130 can be retrieved from multiple medical insurance companies 140 and processed to extract medical necessity criteria related to medical procedures associated with or requested by a health professional. The medical necessity criteria can be provided in an e-learning session 150 integrated with a health record workflow related to the health professional 120. In addition, readily available claims data provided by each healthcare professional practice or hospital can be analyzed using advanced healthcare analytics. The e-learning platform 200 can provide a comprehensive library of customized content based on a unique set of data of each healthcare professional related to his or her clinical services. The library can be created through complex analysis and data mining techniques of billing and claims data in order to perform a detailed payer analysis, case mix analysis, demographic analysis diagnostic code, and current procedural terminology (CPT) code profiling, which can be highly customized for each provider participating in the e-learning platform 200. The e-learning platform 200 can use claims data produced by any EHR or even reports produced by other software for revenue cycle management, quality reporting, or population health management.

The e-learning platform 200 can accommodate sites with low bandwidth, allow easy transition between different operating systems, be delivered via a mobile application or be web-based, and have the benefit of an advanced content management system allowing instant creation and updating of e-learning. Healthcare professionals 120 can use voice activated search functions or browse and save their favorite solutions. They can instantly access the information relevant to their own specific payer-mix, case-mix, and their most frequently used diagnostic codes or medical/surgical services provided. Computer learning technologies can further facilitate search within the e-learning platform 200.

The e-learning platform 200 can provide health professionals with highly customized, bite-sized learning sessions delivered on demand in 3-5 minutes via their own client devices. Healthcare administrators can have less productivity loss due to decreased time invested in healthcare professional training and increased revenue due to fewer denials and fewer value-based purchasing (VBP) penalties related to insufficient medical documentation.

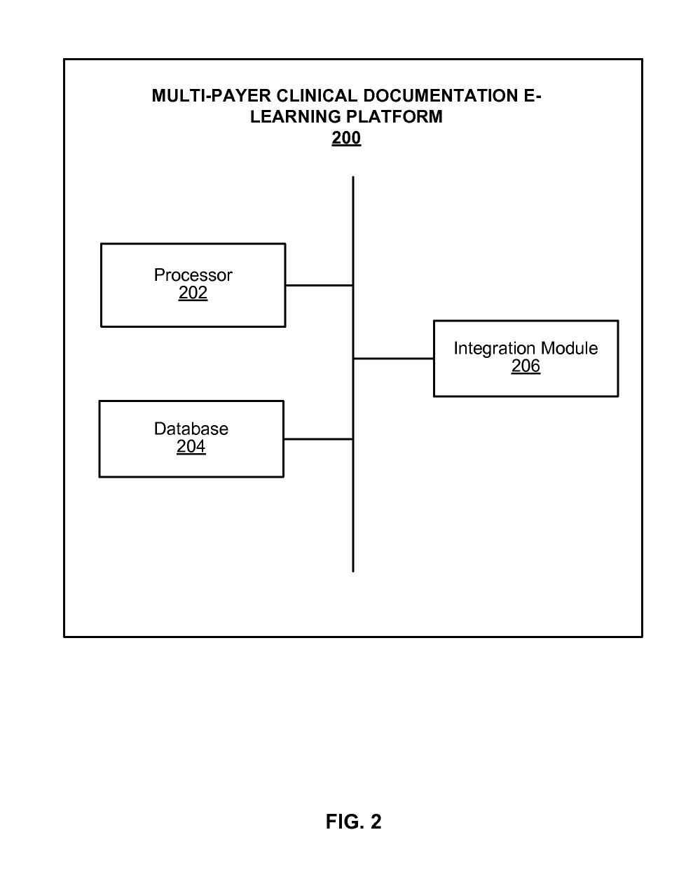

FIG. 2 is a block diagram showing various modules of the multi-payer clinical documentation e-learning platform 200, in accordance with some example embodiments. The e-learning platform 200 may comprise a processor 202, a database 204, and an integration module 206. The processor 202 may include a programmable processor, such as a microcontroller, central processing unit (CPU), and so forth. In other embodiments, the processor may include an application-specific integrated circuit (ASIC) or programmable logic array (PLA), such as a field programmable gate array (FPGA), designed to implement the functions performed by the system.

In various embodiments, the e-learning platform 200 may reside on the network of an organization or outside the organization in a data center provided as a computing cloud service. The database 204 may be operable to dynamically compile health plan data associated with a plurality of health plans. The processor 202 may be operable to analyze the data and to extract the medical necessity criteria for at least one medical procedure. The integration module 206 may be operable to selectively integrate health records with one or more e-learning sessions to educate the at least one health professional about the medical necessity criteria in the context of the at least one medical procedure.

The e-learning platform 200 can provide health professionals with the educational component about medical necessity criteria they need for certain procedures (for example, surgical and medical procedures) based on all the government and private specifications published on corresponding websites. Basically, the e-learning platform 200 collects a specific number of procedures that have high volume or high dollar amount. Additionally, all the medical and specific information can be gathered from payer websites, specifically, top payer websites that have their guidelines posted, such as, for example, Blue Cross, Aetna, United, and Cigna. Based on certain regions, where a more significant share of the market is present, some payers that are relevant to that market may be added.

When a database of information is created, the e-learning platform 200 can customize the database 204 and allow a healthcare professional or other professionals within the practice to have access to this information, to appropriately document the condition in order to get approved by the payers. This approach can allow solving a problem of timely health professional education. In order for a doctor to receive a payment or authorization from a company to perform a specific procedure, laboratory analysis, or medication, the doctor may have to satisfy certain requirements before the procedure is rendered, in terms of evaluation of the patient, referrals from the primary care provider and others, providing specific diagnosis codes, and so forth. To add complexity, these requirements differ from payer to payer and change over time. The e-learning platform 200 can gather information from insurance companies available on their sites and provide the information in e-learning sessions based on the case (i.e., the patient) with an objective of capturing data and providing updates.

Moreover, the health plan information may not be easy to read. Accordingly, the e-learning platform 200 can package and reorganize this information into an easy-to-read, useable format for healthcare professionals, such as healthcare professionals or their extenders (e.g., nurses and case management staff). By using the e-learning platform 200, health professionals can learn how to use health plan data for appropriate documentation, appropriate management of the case, and appropriate work up of the case so that the procedure will not be denied and cause financial consequences.

Additionally, the health plan data can be organized to fit a workflow utilized by the healthcare professionals, whether they use electronic services or paper documents. Thus, e-learning sessions can model the thinking and workflow of healthcare professionals.

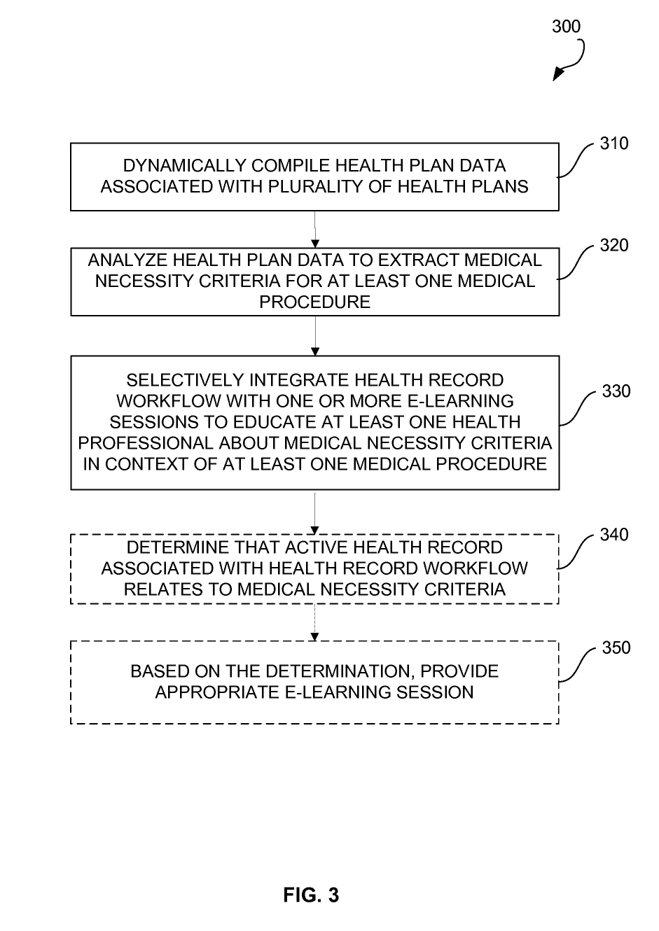

FIG. 3 is a flow chart 300 illustrating a method for educating at least one health professional about medical necessity criteria associated with a plurality of health plans, in accordance with some example embodiments. The method may commence with dynamically compiling health plan data associated with a plurality of health plans at operation 310. The health plan data may be retrieved from online resources associated with a plurality of payers in the medical area (for example, medical insurance companies). The health plan data may include policies and rules, guidelines, documentation requirements, coverage determination criteria, medical necessity criteria, and other data of the payers. The health plan data may be analyzed to extract medical necessity criteria for medical procedures at operation 320. During the analysis, the e-learning platform may mine the data for billing and claim information, perform detailed payer analysis, and so forth. The medical procedures may include a medical service or a surgery rendered to a patient (for example, a bariatric surgery, laboratory analysis, imaging, medication, and so forth). The health professional may specify the medical procedures of particular interest or, alternatively, the e-learning platform may select medical procedures based on historical data of the health professional.

A health record workflow (e.g., EHR workflow) may be integrated with an e-learning session to educate the health professional about the medical necessity criteria related to a medical procedure at operation 330. The medical procedure may include a surgery, a laboratory examination, an imaging, a medication, and so forth. The e-learning platform can interface with an EHR. Thus, the e-learning session may provide medical necessity criteria for a specific medical procedure in a convenient summary form. The medical necessity criteria may be provided for the plurality of health plans from various payers. This way, the health professional can obtain and remember the information that otherwise would have to be collected from various sources without clear applicable criteria. Moreover, an e-learning session can train a health professional on how to document clinical findings with regards to a specific medical procedure. To facilitate access to an e-learning session, the e-learning platform may be provided via a mobile technology, via a web-based technology, and by other means.

In some embodiments, the e-learning platform may determine that an active health record associated with a health record workflow relates to a medical necessity criteria at optional operation 340. If this is the case, the e-learning platform may provide a corresponding e-learning session to educate the user on how to provide proper documentation and to support the user in his daily activity at operation 350. Additionally, claims data produced by a health record workflow in view of the medical necessity criteria may be analyzed and recommendations to the at least one healthcare professional can be provided. Furthermore, reports produced by third parties may be analyzed and recommendations to the healthcare professional may be updated based on the analysis. In some embodiments, health plan data associated with the plurality of health plans may be periodically recompiled to update the medical necessity criteria.

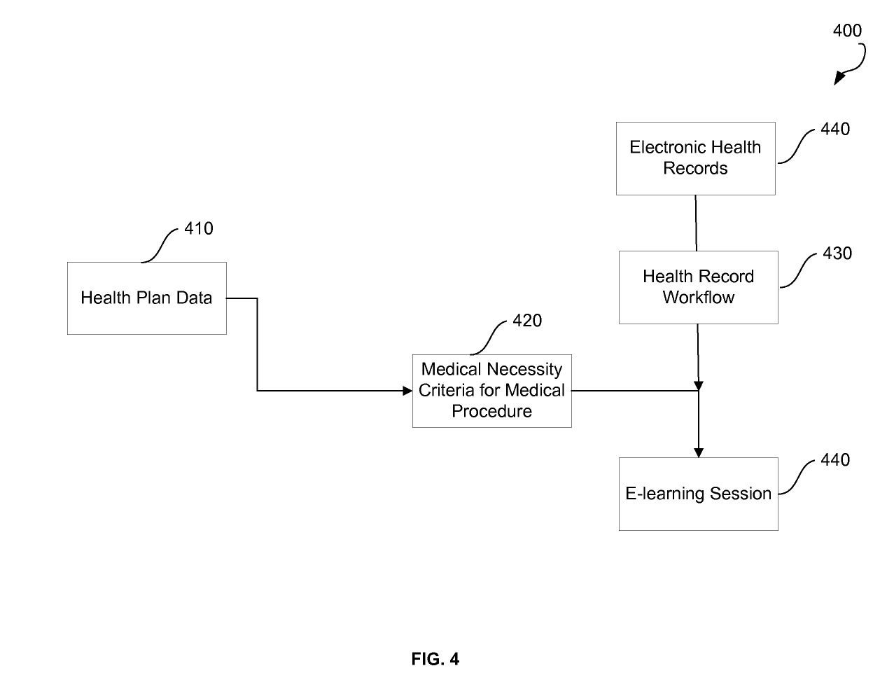

FIG. 4 shows an example analysis 400 of health plan data and a composition of an e-learning session, in accordance to some example embodiments. The health plan data 410 received from medical insurance companies may be processed by the e-learning platform 200 (e.g., Thelos Medical Necessity HealthKit). In result of the processing, the e-learning platform 200 may extract medical necessity criteria for a certain medical procedure 420.

The extracted medical necessity criteria 420 may be integrated into a health record workflow 430 associated with EHRs 440. The medical necessity criteria 420 may be used by the e-learning platform 200 to create an e-learning session 450 that corresponds to the operating environment utilized by the health professional.

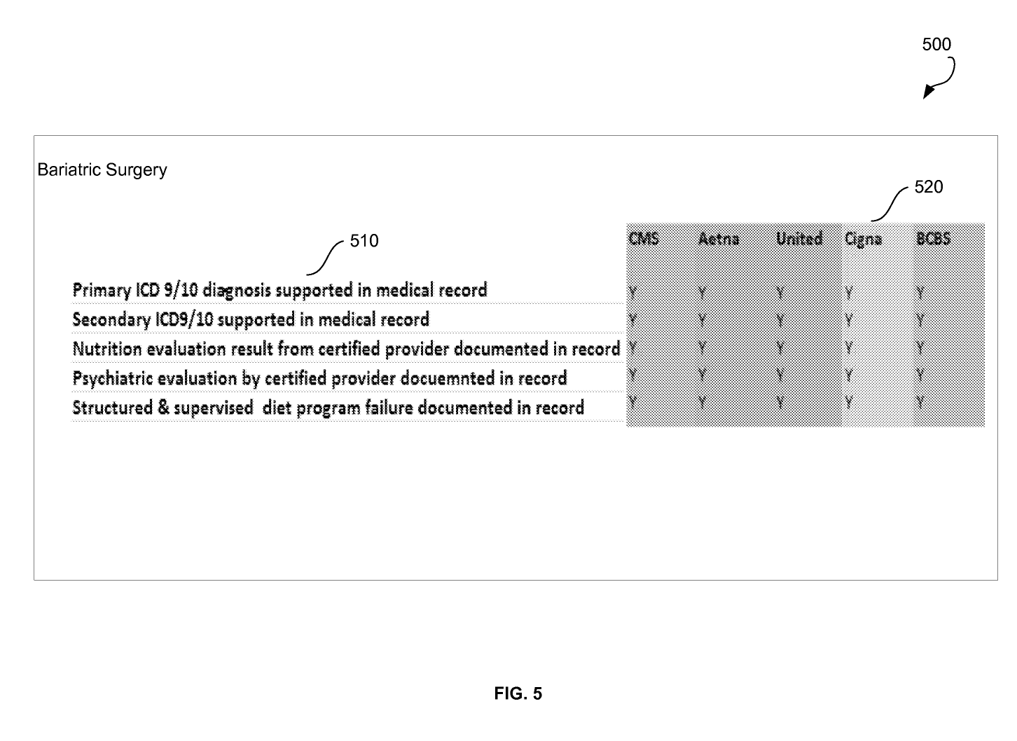

FIG. 5 illustrates a screen 500 with medical necessity criteria for a bariatric surgery, in accordance with some example embodiments. Provided in FIG. 5 are clinical documentation requirements 510 of several payers 520 for a bariatric surgery. The payers 520 shown include the following companies: CMS, Aetna, United, Cigna, and BCBS. The screen 500 provides a summarized view of the medical necessity criteria 510 for each of the payers 520. Healthcare professionals performing bariatric surgery for 5 different patients, each with different health plan, would be trained on how to document their clinical findings as accurately as possible per the guidelines and criteria established by the health plans associated with these 5 different patients. It may be important how much the patient weighs, how tall the patient is, and his/her Body Mass Index (BMI) index. Many doctors are not aware of the criteria for each insurance company because the criteria vary. For some insurance companies, it is enough to have the BMI at a certain number; for other insurance companies, it is important to have this BMI plus a set of other medical diagnoses as well as the order of procedures. Usually, healthcare professionals are not aware of these varying criteria. Moreover, health care professionals may not know where to find these criteria.

The e-learning platform 200 (e.g., Thelos Medical Necessity HealthKit) can significantly facilitate learning or checking of medical necessity criteria by healthcare professionals. The whole set of other criteria (such as a diagnosis code for insurance approval, additional codes for insurance approval for a specific surgery, specific work up that is required in order to even qualify for the surgery, and so forth) can vary for each insurance company. Additionally, the criteria needed to be satisfied in case of complications can also vary. The e-learning platform 200 can allow healthcare professionals to estimate the probability of an insurance company payment in specific cases and provides information on how to increase that probability. E-learning sessions can inform healthcare professionals what kind of intervention can be approved, what criteria need to be satisfied for an adolescent versus an adult, what kind of procedures can be approved for each insured, and so forth. There can be multiple ways to perform a procedure such as, for example, a gastric bypass, and some insurance companies can only approve some of such procedures.

Conventionally, once an insurance payment is denied, the healthcare professional appeals the denial and attempts to provide information based on the reasons for the denial. The e-learning platform 200 provides a specific algorithmic flow that educates health care professionals as to what procedures to perform as well as facilitating documentation of procedures in order to be approved by a specific payer. There can be additional insurance requirements. Some payers, for example, can require diet and exercise for a certain period of time, with a specific certified trainer, and so forth. Other payers may also require a psychiatric clearance, a letter from a primary care physician, and so forth. Example supporting documentation for CMS, Aetna, United, Cigna, and BCBS is provided in Appendix 1.

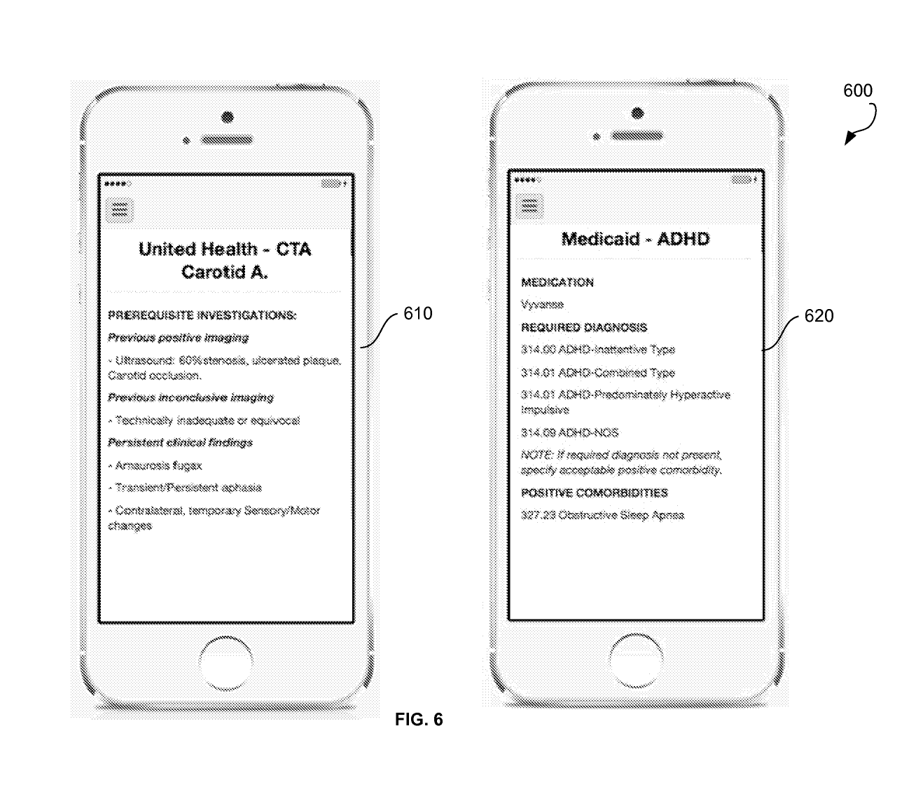

FIG. 6 shows example screens 600 of the e-learning platform, in accordance with some example embodiments. The screens 600 may be accessible upon request by a healthcare professional provided by a text input, voice, or otherwise. For example, the healthcare professional may request imaging medical necessity information for a specific payer. The imaging medical necessity screen 610 may be provided as shown by FIG. 6. Additionally, the e-learning platform may provide medical necessity education and decision/performance support with regards to medication. Such a decision/performance support screen 620 may provide data regarding a diagnosis or condition that a specific payer considers necessary for prescribing a medication.

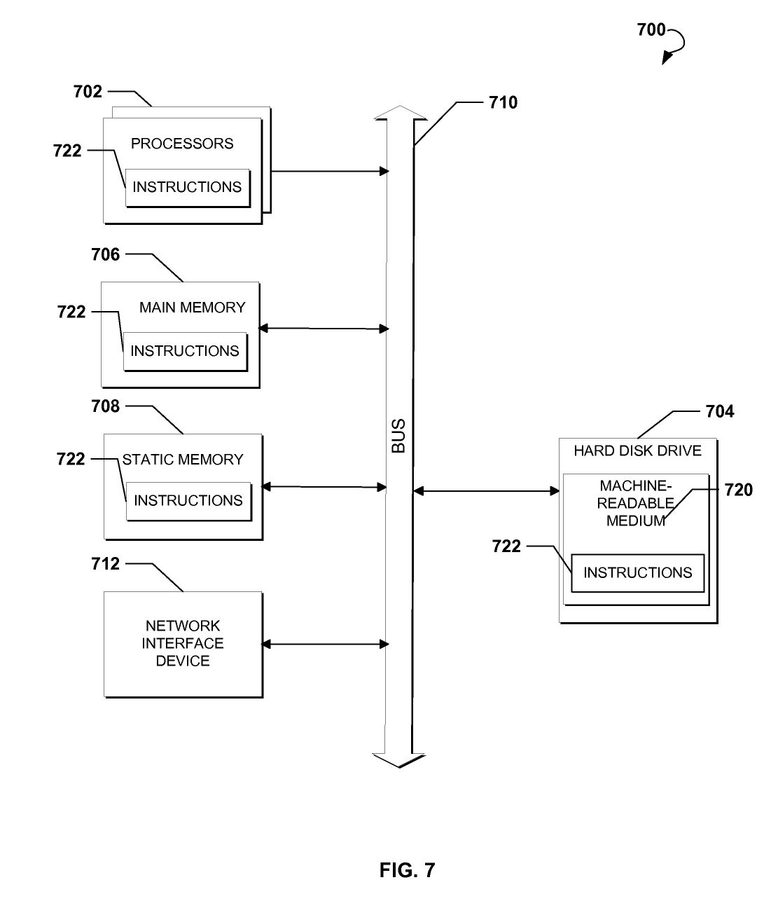

FIG. 7 shows a diagrammatic representation of a computing device for a machine in the exemplary electronic form of a computer system 700, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a server, a PC, a tablet PC, a set-top box (STB), a PDA, a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702, a hard disk drive 704, a main memory 706, and a static memory 708, which communicate with each other via a bus 710. The computer system 700 may also include a network interface device 712. The hard disk drive 704 may include a computer-readable medium 720, which stores one or more sets of instructions 722 embodying or utilized by any one or more of the methodologies or functions described herein. The instructions 722 can also reside, completely or at least partially, within the main memory 706 and/or within the processors 702 during execution thereof by the computer system 700. The main memory 706 and the processors 702 also constitute machine-readable media.

While the computer-readable medium 720 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, RAM, ROM, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, Python, Javascript, Go, or other compilers, assemblers, interpreters, or other computer languages or platforms.

Thus, a multi-payer clinical documentation e-learning platform and computer-implemented methods for educating at least one health professional about medical necessity criteria associated with a plurality of health plans are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

1. A method for educating at least one health professional about medical necessity criteria associated with a plurality of health plans, the method comprising:
dynamically compiling health plan data associated with the plurality of health plans;
analyzing the health plan data to extract the medical necessity criteria for at least one medical procedure; and
selectively integrating a health record workflow with one or more e-learning sessions to educate the at least one health professional about the medical necessity criteria in the context of the at least one medical procedure.

2. The method of claim 1, further comprising:
determining that an active health record associated with the health record workflow is associated with the medical necessity criteria; and
based on the determination, providing an appropriate e-learning session.

3. The method of claim 2, wherein the one or more e-learning sessions are provided to the at least one health professional via a mobile technology.

4. The method of claim 2, wherein the one or more e-learning sessions are provided to the at least one health professional via a web-based technology.

5. The method of claim 2, wherein the e-learning session is operable to train the at least one medical professional on how to document clinical findings.

6. The method of claim 1, wherein health plan data includes at least one of the following: a medical policy, a guideline, a documentation requirement, a coverage determination criterion, and a medical necessity criterion.

7. The method of claim 1, wherein the health record workflow includes an Electronic Health Records (EHR) workflow.

8. The method of claim 1, wherein the analyzing the health plan data includes:
mining the data for billing and claim information; and
performing detailed payer analysis.

9. The method of claim 1, further comprising:
analyzing claims data produced by the health record workflow in view of the medical necessity criteria; and
based on the analysis, providing recommendations to the at least one healthcare professional.

10. The method of claim 1, further comprising:
analyzing one or more reports produced by one or more third parties; and
based on the analysis, updating recommendations to the at least one healthcare professional.

11. The method of claim 1, further comprising periodically recompiling health plan data associated with the plurality of health plans to update the medical necessity criteria.

12. The method of claim 1, wherein the at least one medical procedure includes a medical service or a surgery rendered to a patient.

13. A multi-payer clinical documentation e-learning platform comprising:
a database operable to dynamically compile health plan data associated with a plurality of health plans;
a processor operable to analyze the data to extract medical necessity criteria for at least one medical procedure; and
an integration module operable to selectively integrate a health record with one or more e-learning sessions to educate at least one health professional about the medical necessity criteria in context of the at least one medical procedure.

14. The platform of claim 13, wherein health plan data includes at least one of the following: a medical policy, a guideline, a documentation requirement, a coverage determination criterion, and a medical necessity criterion.

15. The platform of claim 13, wherein the health record procedure includes an Electronic Health Records (EHR) workflow.

16. The platform of claim 13, wherein the e-learning session is operable to train the at least one medical professional on how to document clinical findings.

17. The platform of claim 13, wherein the analyzing the health plan data includes:
mining the data for billing and claim information; and
performing detailed payer analysis.

18. The platform of claim 13, wherein the processor is further configured to:
analyze claims data produced by the health record workflow in view of the medical necessity criteria; and
based on the analysis, provide recommendations to the at least one healthcare professional.

19. The platform of claim 13, wherein the processor in further configured to: periodically recompile health plan data associated with the plurality of health plans to update the medical necessity criteria.

20. A non-transitory computer-readable medium comprising instructions, which when executed by one or more processors, perform the following operations:
dynamically compile health plan data associated with a plurality of health plans;
analyze the health plan data to extract medical necessity criteria for at least one medical procedure; and
selectively integrate a health record workflow with one or more e-learning sessions to educate at least one health professional about the medical necessity criteria in context of the at least one medical procedure.
